(19) United States
(12) Patent Application Publication
(10) Pub. No.: US 2005/0225861 A1
(43) Pub. Date: Oct. 13, 2005

(54) Segmented complex diffraction gratings

(76) Inventors: Thomas Mossberg, Eugene, OR (US); Michael Munroe, Eugene, OR (US); Anders Grunnet-Jepsen, Eugene, OR (US); Alan Johnson, Eugene, OR (US); Eric Maniloff, Eugene, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/145,291

(22) Filed: Jun. 3, 2005

Related U.S. Application Data
(62) Division of application No. 09/115,331, filed on Jul. 14, 1998.
Application No. 09/115,331 is a continuation-in-part of application No. 09/100,592, filed on Jun. 19, 1998, now abandoned.
Application No. 09/115,331 is a continuation-in-part of application No. 08/897,814, filed on Jul. 21, 1997, now Pat. No. 5,812,318.
Application No. 08/897,814 is a continuation of application No. 08/403,376, filed on Mar. 13, 1995, now abandoned.
(60) Provisional application No. 60/070,684, filed on Jan. 7, 1998.

(51) Int. Cl. G02B 6/34; G02B 5/18

(52) U.S. Cl. 359/569

(57) ABSTRACT

A structure (i.e. a segmented grating) which applies a designated complex-valued spectral filtering function to the input optical field and emits a filtered version of the input field in an output direction and a method for making such a structure. The segmented gratings fabricated in accordance with the present invention consist of a series of spatially distinct subgratings arrayed end to end. Each subgrating possesses a periodic array of diffraction structures (lines or more general elements). The overall transfer function of the segmented grating is determined by controlling (a) the spatial periodicity or frequency of each subgrating, (b) the amplitude of each subgrating, (c) the spacing between the last diffraction structure (or line) on each subgrating and the first diffraction structure (or line) of the successive subgrating, and (d) the optical path length and transparency through each subgrating, or each subgrating plus additional material layers utilized to control optical path length and transparency.

### RELATED APPLICATIONS

The present application is a continuation in part of application Ser. No. 09/100,592 which was filed Jun. 19, 1998 and which is now pending, a continuation in part of Provisional Application 60/070,684, which was filed Jan. 1, 1998, and a continuation in part of application Ser. No. 08/897,814 filed Jul. 21, 1997 and which is now pending and which is a continuation of application Ser. No. 08/403,376 which was filed Mar. 13, 1995 and which is now abandoned.

### FIELD OF THE INVENTION

The present invention relates to optical communication systems and more particularly to the use of complex gratings in communication systems.

### BACKGROUND OF THE INVENTION

Many present optical communication systems utilize wavelength division multiplexing (WDM) to increase the capacity of optical fibers. Copending patent application Ser. Nos. 08/403,376 and 60/070,684 which are referenced above describe a technology for increasing the capacity of optical systems by utilizing a different type of multiplexing which can be termed optical code division multiple access (hereinafter OCDMA). OCDMA systems encode different communication channels with different temporal codes as contrasted to the coding in WDM systems wherein different channels use different wavelengths of light.

Co-pending patent applications Ser. Nos. 08/403,376 and 60/070,684 describe diffraction gratings which consist of multiple sinusoidal subgratings, each subgrating having a specific amplitude and spatial phase. Such gratings can deflect optical pulses from a specific input direction to a specific output direction while simultaneously multiplying the Fourier spectrum of the input pulse by a predetermined filtering function. The output signals are a cross-correlation between the input waveform and the grating encoded temporal waveform. The gratings described in the referenced co-pending applications have a complex profile. They can accept input beams and generate spectrally filtered output beams propagating in one or more output directions. The filtering function of the device is programmed by choice of grating profile. By suitable programming, multiple transfer functions may be realized, each having its own specific input and output direction.

### SUMMARY OF THE PRESENT INVENTION

The present invention provides a structure (i.e. a segmented grating) which applies a designated complex-valued spectral filtering function to the input optical field and emits a filtered version of the input field in an output direction and a method for making such a structure. Grating devices, comprised of one or more segmented gratings after the present invention can be used, for example, in OCDMA data links to temporally code optical signals with specific codes such that multiple coded channels can simultaneously be transmitted through the same link and then be decoded into separate channels at the output of the system. The segmented gratings of the present invention can also be utilized in any application area wherein the ability to effect programmable spectral filtering is utilized. The segmented gratings fabricated in accordance with the present invention consist of a series of spatially distinct subgratings arrayed end to end. Each subgrating possesses a periodic array of diffraction structures (lines or more general elements). The overall transfer function of the segmented grating is determined by controlling (a) the spatial periodicity or frequency of each subgrating, (b) the amplitude of each subgrating, (c) the spacing between the last diffraction structure (or line) on each subgrating and the first diffraction structure (or line) of the successive subgrating, and (d) the optical path length and transparency through each subgrating, or each subgrating plus additional material layers utilized to control optical path length and transparency.

### BRIEF DESCRIPTION OF THE FIGURES

FIG. 1A is an overall diagram of a multiplexing/demultiplexing system utilizing the present invention.

FIG. 1B shows in more detail one of the optical paths shown in FIG. 1A.

FIG. 2A shows a top view of a segmented grating fabricated in accordance with the present invention.

FIG. 2B shows a side view of a segmented grating fabricated in accordance with the present invention.

FIG. 3A is a schematic diagram showing the input angle and the output angle at which light is passed through the segmented grating.

FIG. 3B is a schematic diagram showing the angle between the plane containing the input and output beams and the x axis, as measured in the x-y plane.

FIG. 3C shows a temporally coded optical pulse composed of 4 time slices that is incident on a segmented grating of 4 contiguous equal width subgratings.

FIG. 4 shows a first technique for fabricating segmented gratings according to the present invention.

FIG. 5 shows a second technique for fabricating segmented gratings according to the present invention.

FIG. 6 shows a third technique for fabricating segmented gratings according to the present invention.

FIG. 7 shows a side view of two subgratings of a segmented grating with different optical thickness.

FIG. 8 shows a side view of two subgratings of a segmented grating which have a saw tooth blaze.

FIG. 9 shows a four channel OCDMA system.

### DETAILED DESCRIPTION OF A PREFERRED EMBODIMENT

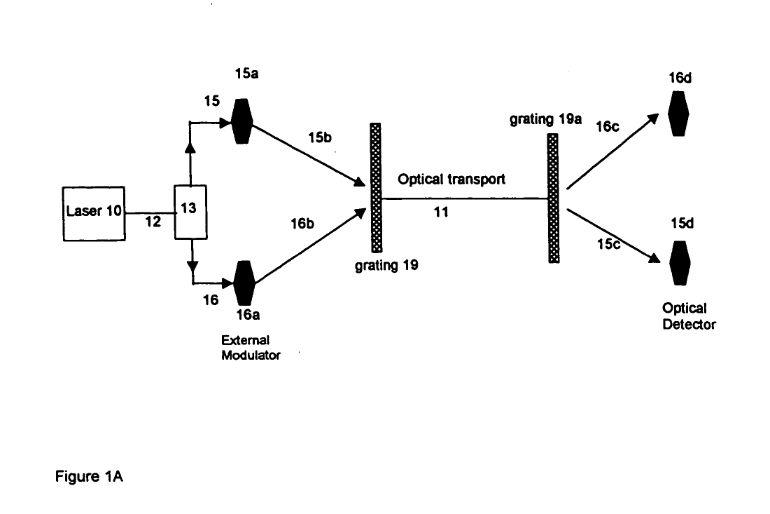

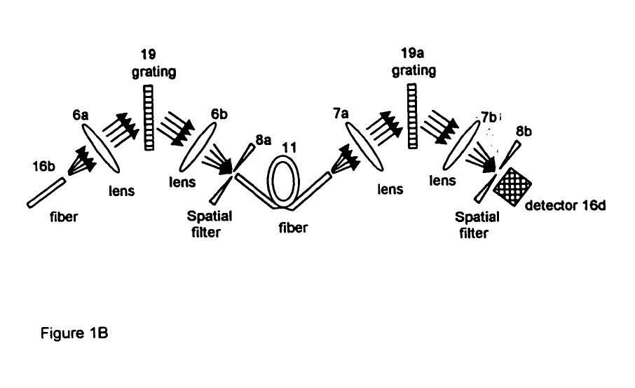

FIG. 1A is an overall diagram of an OCDMA communication system which utilizes the segmented diffraction grating of the present invention to perform optical multiplexing and demultiplexing. Short-pulse laser 10 generates a coherent beam of light 12. Beam splitter 13 divides the light into two beams 15 and 16. Beams 15 and 16 are each individually modulated by modulators 15a and 16a respectively, thereby generating modulated beams 15b and 16b. The modulation of each of the beams is done in response to an external data stream not explicity shown in FIG. 1. Beams 15b and 16b consist, either by virtue of the operative character of the laser source 10, the action of the modulators 15a and 16a, or a combination of the two, of a stream of bits whose temporal character matches the designed input pulses of grating 19.

Each of the beams 15b and 16b is directed at grating 19 so that it is incident on the grating 19 at an angle that differs for each beam. Grating 19 is a grating device comprised of two superimposed segmented gratings operative on beams 15b and 16b to produce separate output time codes in optical transport 11 for each of the input beams. (The coding technique and the details of grating 19 are described below). The combined coded beam is transported to a second grating 19a via an optical transport device 11 which may for example be an optical fiber. Grating 19a is a grating device also composed of two superimposed segmented gratings operative on the time codes in beam 11 to produce output beams 15c and 16c, respectively. Beams 15c and 16c are modulated identically to the corresponding beam 15a or 16a, respectively. (The decoding technique and the details of grating 19a are described below). The content of beams 15c and 16c is detected by detectors 15d and 16d and it is thus turned back into electrical signals which correspond to the signals that activated modulators 15a and 16a.

It is noted that while the embodiment shown herein combines two beams into one coded beam, three, four, or more beams could similarly be multiplexed into one beam using OCDMA coding. The combined coded beam could be transmitted over a transmission system and then the beams could be demultiplexed into the original signals. FIG. 1B shows the optical lenses and spatial filters associated with passing one of the beams through gratings 19 and 19a. As shown in FIG. 1B the light beam 16b is passed through a collimating lens 6a so that the light beam illuminates the entire operative width of the two dimensional segmented grating 19sg16 contained within grating device 19. A second lens 6B focuses the light passing through grating device 19 into optical transport 11. Spatial filtering provided by means of a dedicated element 8a or consequent to entry into the optical transport selects the operative angular output channel of the segmented grating 19sg16. At the end of optical transport 11 a second collimating lens 7a illuminates segmented grating 19asgl6 over (constituent to grating device 19a) over its operative width and the light passing through grating 19a is focused by collimating lens 7b. A spatial filter 8b following lens 7b selects the operative output angular channel of the segmented grating 19asgl6 of grating 19a. FIG. 1B only shows the elements associated with one data path. The system includes mechanism for collimating each of the beams 15b and 16b, and providing for said beams to illuminate corresponding segmented gratings 19sg15 and 19sg16 within grating 19 at a different angle. A separate lens 6a for each input beam provides an exemplary mechanism. Alternatively, a single lens and control over the launch conditions of the input beams toward the single lens provides equivalent function. Exemplary spatial control comprises a spatial filter in the front focal plane of said single lens with apertures sufficiently small to provide diffractive grating filling. At the output of grating 19a, there is a mechanism for providing a spatial Fourier decomposition of the angular output of the segmented gratings comprising grating 19a and appropriate spatial filtering mechanisms for selecting the multiple operative angular output channels. A single lens provides an exemplary mechanism for providing spatial Fourier decomposition. Apertures placed in the focal plane of said single lens then provides means of selecting operative angular channels. Other means for selecting operative angular channels are are known in the art

Gratings 19 and 19a through their constituent segmented gratings are designed to accept light from one or more directions and to redirect the light into one or more output directions in a manner that is dependent on the temporal waveform of the input light. Considering a specific input direction and one of the output directions associated with this specific input direction, the grating's functions can be summarized as follows: A portion of each spectral component of the input light field is mapped into the output direction with a controlled amplitude and phase. The grating applies a designated complex valued spectral filtering to the input optical field and emits the filtered version of the input field in the output direction. The spectral resolution of the filtering function is determined by the physical size of the enabling segmented grating constituent to the operative grating device along with the input and output angles of the light beam relative to the grating. The spectral mapping between each input direction and each output direction may be programmed essentially independently through use of dedicated segmented gratings for each mapping. This is explained in the previously referenced co-pending applications, the description of which is incorporated herein by reference. In the present invention, each independently controllable spectral transfer function is controlled by a segmented grating.

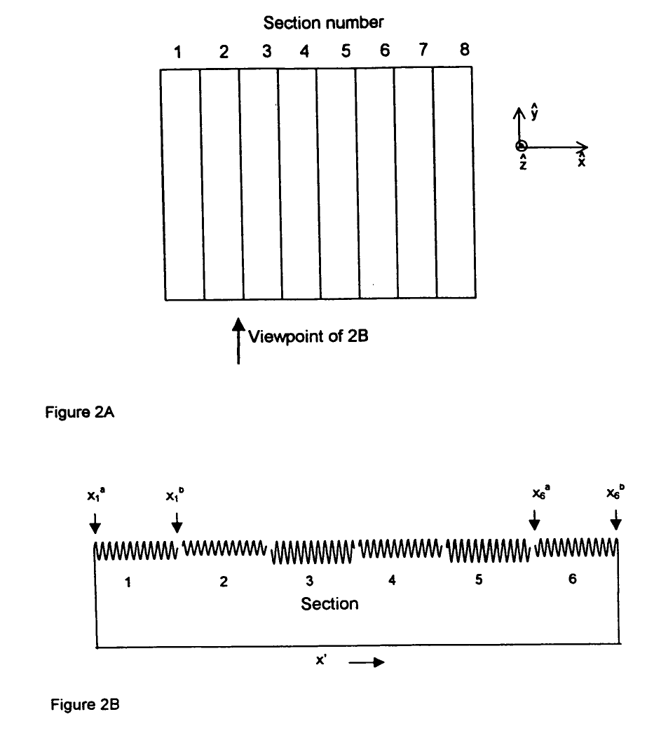

FIG. 2A shows one segmented grating fabricated in accordance with the present invention. Grating 19 and 19a contain two such structures superimposed on each other as to form one combined grating. The combined grating thus incorporates the structure of the two individual segmented gratings. We focus now on the design of a single segmented grating. Grating devices incorporating multiple segmented gratings are designed through repetitive application of single segmented grating procedures. The segmented grating has N spatially distinct subgratings or sections 1 to N. In the embodiment shown N is equal to eight. An exemplary cross section of the segmented grating is shown in FIG. 2B. FIG. 2B is only presented for illustrative purposes to show that the line structure on each of the subgratings comprising the segmented grating has its own amplitude and phase.

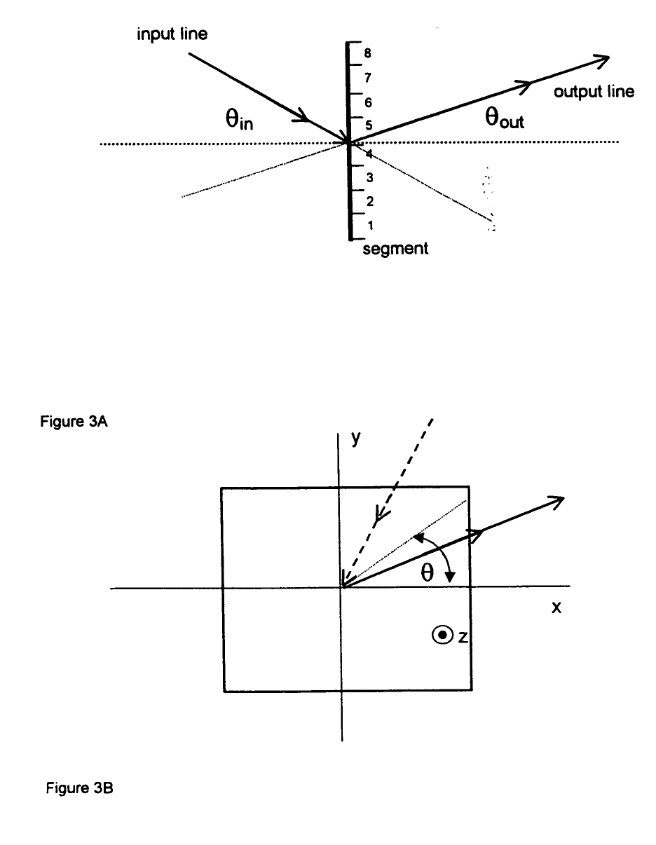

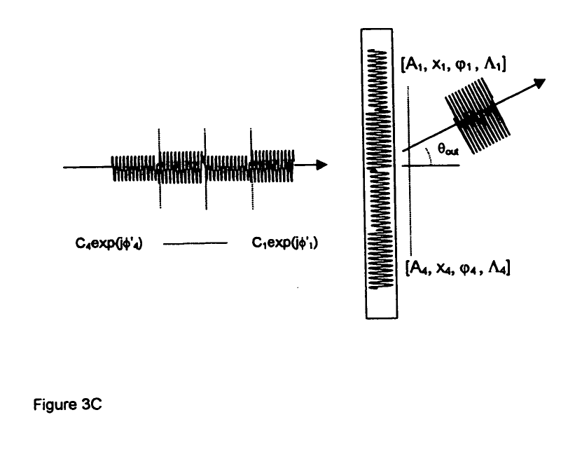

In order to mathematically define the structure of the subgratings contained within one segmented grating, it is first necessary to define a set of coordinates and angles descriptive of the segmented grating and associated optical input and output directions. For convenience, we chose the origin of the reference coordinate axes to lie in the center of the segmented grating. The segmented grating surface is taken to coincide with the x-y plane. We define two lines each of which passes through the coordinate center with the first line parallel to the optical input direction and the second parallel to the optical output direction. We refer to these two lines as the input and output lines, respectively. The input and output lines define a plane, referred to herein as the input/output plane. The mathematics presented herein has the x-axis located in the input/output plane. Other embodiments of the invention could have structures wherein the z-axis is noncoplanar with the input and output lines. FIGS. 3A and 3B show a schematic diagram of a segmented grating structure showing input angle (θᵢₙ) and output angle (θₒᵤₜ) in the input/output plane. The angular separation between the input (output) direction and the z axis is θᵢₙ (θₒᵤₜ), where the angles are positive as shown in FIG. 3A. FIG. 3B shows the angle θₐ between input/output plane and the x axis as measured in the x-y plane. Thus, FIGS. 3A and 3B show the geometrical arrangement of a segmented grating relative to a particular input and output optical field. For the particular segmented grating under consideration, we define the groove-normal line as the line perpendicular to the grooves lying in the plane of the segmented grating surface and passing through the origin. As described above, the groove-normal line is contained within the input/output plane. Other embodiments of the invention could have a groove-normal line at other locations relative to the input/output plane.

When the input/output plane contains the z axis, the diffractive structures (grooves) that redirect and spectrally filter the input optical beam into the output direction lie perpendicular to the input/output plane and lie within or on the surface of the segmented grating. We reiterate that multiple segmented gratings having the same or different values of θₐ can be colocated on the same substrate with any degree of overlap. Grating devices may require a single segmented grating structure, multiple spatially superimposed segmented grating structures, or a combination of spatially superimposed and spatially separated segmented grating structures fabricated onto a single substrate. Grating 19 in FIG. 1A is comprised of two segmented grating structures.

Grating 19 utilizes transmissive segmented gratings, but all particulars discussed herein can be transferred as known in the art to a reflective grating geometry. Each input optical beam illuminates the active width of each segmented grating structure with which it is intended to interact. It is noted that grating 19 and the segmented gratings that it supports are essentially planar and arranged parallel to the x-y coordinate plane. As in the case of simple monospaced diffraction gratings, segmented gratings may be implemented with nonplanar surface geometry. For example a segmented grating could be supported by a nonplanar (e.g. concave) substrate. The use of non-planar surface geometry allows for the control over the spatial wavefront of input optical beams in addition to the spectral content control that is afforded by grating segmentation.

A single segmented grating structure is fabricated in the form of a series of N spatially distinct subgratings arrayed side to side whose collective span defines the operative width of the segmented grating. Each subgrating possesses a periodic array of diffractive structures (grooves) arranged in a plane perpendicular to the input/output plane. The spacing between diffractive structures within the N successive spatial subgratings is typically but not necessarily the same. The N subgratings are written or otherwise created on the grating such that each occupies a specific subsection of the overall grating surface and subgratings appear successively as one passes along the groove-normal line. All subgrating constituents of a particular segmented grating typically but not necessarily have the same span perpendicular to the groove-normal line, i.e. height. The spatial interval between the last diffractive structure (groove) of each subgrating and the first diffractive structure (groove) of the successive subgrating is controlled as will be described.

Control over groove positioning provides control over relative spatial phase of adjacent subgratings. Also controlled is the amplitude of the diffractive structures within a given subgrating. The manner in which subgrating spacing and amplitude is controlled determines the spectral transfer function of the grating. The optical thickness of the various subgratings comprising a segmented grating structure can be controlled by variation of substrate thickness, addition of phase masks, or other means known in the art to provide additional control over the spectral transfer function of the grating. Variation of optical thickness under a spatial subgrating or the separation between subgratings both act to control the relative phase of light transferred from the input to the output directions. Active devices can be added between the subgratings to dynamically change subgrating-subgrating separation to allow for the dynamical reprogramming of the spectral filtering function. Active devices to control the optical thickness of subgratings inclusive of overlays can be added to provide an alternative means of dynamical reprogramming of the spectral filtering function.

The representative segmented grating shown in FIG. 2 has eight spatial subgratings. The spatial subgratings have essentially equal extent along the groove normal line; however, spatial subgratings of dissimilar extent can be employed. The representative segmented grating is a transmissive phase grating, but it could be a reflective, amplitude, or other generalized physical grating type.

We represent the transmissive optical phase shift versus position of one constituent subgrating, labeled by the subscript i, of a segmented grating device by the following mathematical expression
hᵢ(x′)=Aᵢfᵢ(2π(x′−xᵢ)/Λᵢ)+φᵢ {for xᵢ^{a}≦x′xᵢ^{b}} (1)
where x′ represents the spatial position coordinate along the groove-normal line, xᵢ is the spatial position shift of the i^{th} subgrating groove pattern, the function fᵢ represents a particular groove profile and is periodic in its argument on the scale of 2π and modulates between the values of 0 and 1, φᵢ is an optical phase shift introduced by a variation in substrate thickness or superimposed phase mask, Aᵢ is a real-valued amplitude factor, xᵢ^{a} and xᵢ^{b} are the edge positions of subgrating i, and Λᵢ is the spatial period of the i^{th} subgrating. Outside the prescribed spatial interval, hᵢ(x′)=0. The subscript i ranges from 1 to N and denotes individual spatial subgratings. By specifying the parameters Aᵢ, φᵢ, xᵢ, and Λᵢ for the subgratings employed, a wide range of spectral filtering functions can be encoded.

The parameters Aᵢ, φᵢ, xᵢ, and Λᵢ necessary to produce specific spectral transfer functions can be chosen in a variety of ways. Assume that a grating is to be constructed that provides a particular spectral transfer function T(ν) (where ν is the optical frequency) as approximated by N transmission coefficients each of which corresponds to one of N contiguous frequency channels collectively spanning the full non-zero width of T(ν). To accomplish this, the segmented grating will require approximately N subgratings. We assume that T(ν) is nonzero over a specific spectral region of width δν centered about the frequency ν₀. To provide filtering with the specified resolution, the subgratings will require a spatial width given approximately by c/[δν(sin θᵢₙ+sin θₒᵤₜ)] where c is the speed of light. The total width of the grating will thus be approximately given by Nc/[δν(sin θᵢₙ+sin θₒᵤₜ)] assuming that the subgratings are laid down contiguously.

For example, if δν=100 GHz, θᵢₙ=0°, θₒᵤₜ=45°, and N=8 the complete spatial width of a segmented grating capable of representing T(ν) will be approximately 3.4 cm.

The parameters (Aᵢ, φᵢ, xᵢ, and Λᵢ) for all of the N subgratings comprising the segmented grating determine its spectral transfer function. Given the subgrating parameters, the spectral transfer function of the segmented grating can be determined. Conversely, given a specific spectral transfer function the subgrating parameters which must be employed to create a segmented grating with that transfer function can be determined. It should be understood that while the mathematics presented herein contain certain constraining assumptions in order to facilitate an explanation of the preferred embodiment of the invention, the equations could be generalized without departing from the invention.

We first give an expression for the spectral transfer function exhibited by a segmented grating in terms of subgrating parameters. Under the assumptions that 1) Aᵢ<<1 or Aᵢ=A=constant, 2) plus or minus first order (m=±1) grating output is employed, and 3) the N subgratings have equal spatial width (d=xᵢ^{b}−xᵢ^{a}=constant), equal spatial period (Λᵢ=Λ=constant), and are laid down contiguously, the spectral transfer function of the segmented grating may be written as a sum over subgrating parameters as follows:

$$T ( v ) = F ( v ) {\sum }_{i = 1}^{N} {a}_{i} exp ( {jΦ}_{i} ) \qquad ( 2 a )$$

where:
aᵢ=Aᵢexp(j(φᵢ−2πxᵢm/Λ)), (2b)
Φᵢ=π(xᵢ^{a}+xᵢ^{b})(βν−m/Λ)), (2c)
and
β=(sin θᵢₙ+sin θₒᵤₜ)/c. (2d)

Here, F(ν) is the spatial Fourier transform of a subgrating given by

$$F ( v ) = \frac{jC}{N} sin c ( π d ( v β - m / Λ ) ) , \qquad ( 2 e )$$

where j is \sqrt{−1}, and C is a constant dependent on the groove profile and contains a phase factor dependent on the choice of x′-origin. The function sinc(x) is defined as equal to sin(x)/x. In writing Eq. (2), it is assumed that the output signal is derived from the plus (m=1) or minus one (m=−1) diffractive order of the subgratings. Analogous expressions for higher and negative orders follow as per known in the art.

If one wishes to design a segmented grating having a specific transfer function, it is necessary to determine appropriate parameters for each subgrating. To do this one first solves Eq. (2a) for aᵢ and obtains

$${a}_{i} = β d {\int }_{m / ( β Λ ) - 1 / ( 2 β d )}^{m / ( β Λ ) + 1 / ( 2 β d )} \frac{T ( v )}{F ( v )} exp ( - jπ ( v β - m / Λ ) ( {x}_{i}^{a} + {x}_{i}^{b} ) ) ⅆ v \qquad ( 3 )$$

From Eq. (2b) one finds that Aᵢ is equal to the amplitude of aᵢ. The quantities xᵢ and Φᵢ both determine the phase of aᵢ as seen in the equations above. An appropriate combination of xᵢ and φᵢ consistent with Eq. (2b) and Eq. (3) can be chosen at the convenience of the grating designer. The parameter Λ is chosen so the light of carrier frequency νₒ is maximally diffracted from θᵢₙ to θₒᵤₜ using the well-known grating equation sin(θᵢₙ)+sin(θₒᵤₜ)=mλₒ/Λ where λₒ=c/νₒ is the center wavelength of the desired transfer function. The angles θᵢₙ and θₒᵤₜ are designer inputs as is T(ν). Mathematically speaking, Λ is chosen as the solution of the mathematical equation βνₒΛ=m.

Alternatively, a more general solution for obtaining the subgrating parameters is to calculate the continuous grating profile that will generate the desired continuous transfer function. If the transmissive phase of a grating as a function of x′ is given by

$$h ( {x}^{′} ) = - j ln [ \sqrt{2 π} β D {\int }_{- ∞}^{+ ∞} T ( v ) exp ( - j2π β {vx}^{′} ) ⅆ v ] , \qquad ( 4 )$$

the spectral transfer function of the grating in direction θₒᵤₜ will be T(ν), where D is the width of the grating. Again θᵢₙ, θₒᵤₜ, and T(ν) are designer inputs. It is necessary to convert the continuous transmissive phase profile given by Eq. (4) to a segmented phase profile consistent with subgrating fabrication. Parameters descriptive of constant phase segments which can be directly mapped onto the parameters defining constituent subgratings can be determined as follows: The continuous surface phase profile, h(x′), will generally consist of a carrier spatial modulation with a slowly varying amplitude and phase shift. A representative average of the spatial phase shift over the physical extent of subgrating i is determined and the values of φᵢ and xᵢ are adjusted in a convenient combination to match the determined spatial phase shift determined from Eq. (4). Similarly, a representative value of the grating amplitude from Eq. (4) within the physical extent of subgrating i is determined and Aᵢ is set equal to this grating amplitude. The spatial period Λᵢ is set equal to the carrier modulation period of h(x′) as given by Eq. (4). A variation to the approach just given is to determine a spatial carrier, amplitude, and phase within the extent of each subgrating separately. This procedure allows for the variation of Λᵢ from subgrating to subgrating.

For a segmented grating to perform the function of optical cross-correlation between optical input waveforms and a reference optical waveform, the grating's spectral transfer function should be the complex conjugate of the spectrum of the reference optical waveform. The function of optical cross correlation here means that the electric field emitted by the grating in the operative output direction represents the temporal cross correlation between a) an input optical waveform incident on the grating along the operative input direction and b) the specific reference optical waveform whose conjugated spectrum coincides with the grating's spectral transfer function.

Consider a reference optical waveform whose time profile is represented as a sequence of N contiguous time slices within which the amplitude and phase of the optical field is constant. In time slice i (i=1, . . . , M), the electric field has constant amplitude Bᵢ and phase φᵢ. The reference waveform is thus determined by the set of complex numbers [B₁exp(jφ₁), B₂exp(jφ₂), . . . , B_{M}exp(jφ_{M})] along with the optical carrier frequency in each time slice and the overall temporal duration of the waveform, FIG. 3C schematically illustrates an input optical waveform of the form [C₁exp(jφ′₁), C₂exp(jφ′₂), . . . , C₄exp(jφ′₄)] incident on a segmented grating.

When an optical waveform is incident on the grating, the grating will spectrally filter the incident waveform as described by the grating spectral transfer function for the particular θᵢₙ and θₒᵤₜ employed. If the grating is to perform the function of cross-correlation against the reference optical waveform, the subgratings should have parameters that are the “time-reversed” complex conjugate of the reference optical waveform, e.g. [a₁, a₂, . . . , a₈]=[B₈exp(−jφ₈), B₇exp(−jφ₇), . . . , B₁exp(−jφ₁)] where the subgrating parameters are related to aᵢ by equation (2b) given the assumptions in deriving Eqs. (2a-3) are met. The operation of cross-correlation may be used to multiplex and demultiplex optical signals.

It is noted that the groove profile affects primarily the diffraction efficiency of the grating. This affects the magnitude of the spectral transfer function or the constant C in Eq. (2e).

The following specifies the gratings employed in an exemplary two-channel multiplex/demultiplex system as in FIG. 1a. Grating devices 19 and 19a used are each composed of two superimposed segmented gratings. Grating 19 accepts uncoded data streams and launches time-coded data into a common channel. Grating 19a accepts time-coded data and launches distinct time codes into distinct output directions while simultaneously stripping off time-coding. Grating 19a functions through the process of cross-correlation.

In the present embodiment, gratings 19 and 19a consist of two superimposed segmented gratings. The net transmissive optical phase shift versus position of the gratings is consequently the sum of the transmissive optical phase shift functions for the two constituent segmented gratings.

In the multiplexer/demultiplexer embodiment presently considered we use a lamellar (square-wave) groove profile with a fifty percent duty cycle. We assume uniform subgrating amplitudes of Aᵢ=π/2 for the first and second segmented gratings, the diffraction efficiency of grating 19 and grating 19a is approximately 20% in the operative output directions. If a transmission grating is to be etched into a substrate with optical index nₒ=1.50, the etch depth that corresponds to Aᵢ=π/2 phase modulation is given by 0.77 μm for a carrier wavelength of 1.54 μm. The input-output plane contains the z-axis in this embodiment. The gratings 19 and 19a have eight subgratings, each subgrating has a width of 1 mm, thus the total grating width is 8 mm. The segmented gratings comprising grating 19 and 19a have θₐ=0° and are designed for optical data streams having the carrier frequency 195 THz (a carrier wavelength λ=1.54 μm).

The optical data channels controlled by a first segmented grating constituent of grating 19 are specified to have the input and output angles θᵢₙ=17.94° and ←ₒᵤₜ=0°. The grating spacing is Λ=5 μm for all subgratings of the first segmented grating. The first segmented grating is designed to accept temporally short input pulses of optimal duration Δθₚ=1 ps along θᵢₙ=17.94° and generate temporally coded pulses along the multiplexed output direction θₒᵤₜ=0°. To produce output pulses of approximate duration τₚ=8 pS with the following temporal code
[1, 1, 1, exp(j2π/3), exp(j4π/3), 1, exp(j4π/3), exp(j4π/3)]
   the corresponding subgrating xᵢ and φᵢ parameters for the first segmented grating are
[x₁, x₂, . . . , x₈]=[0.0 μm, 0.0 μm, 0.0 μm, −1.67 μm, 1.67 μm, 0.0 μm, 1.67 μm, 1.67 μm] and
[φ₁, φ₂, . . . , φ₈]=[0,0,0,0,0,0,0,0].
   The second segmented grating consists of a set of eight subgratings with the following common specifications: Λ=3 μm, θᵢₙ=30.89°, θₐ=0°, and θₒᵤₜ=0°. The second segmented grating, like the first, accepts temporally brief data bits of optimal duration Δθₚ≈1.71 ps moving along its input direction and generates temporally coded bits of approximate duration τₚ=13.7 ps into its output direction. Segmented gratings one and two have a common output direction. If the coded output bits from segmented grating two are to have the following form
[1, exp(j2π/3), exp(j4π/3), 1, exp(j2π/3), exp(j4π/3), 1, exp(j2π/3)],
   the corresponding subgrating parameters of the second segmented grating are
[x₁, x₂, . . . , x₈]=[0.0 μm, −1.0 μm, 1.0 μm, 0.0 μm, −1.0 μm, 1.0 μm, 0.0 μm, −1.0 μm] and
[φ₁, φ₂, . . . φ₈]=[0,0,0,0,0,0,0,0].

The filtering bandwidth of the second segmented grating is δν≅1/Δτₚ or 0.6 THz.

The multiplexed beams copropagating in optical transport 11 may be demultiplexed at grating 19a. The demultiplexing grating 19a in FIGS. 1A and 1B is identical in design to grating 19. For an input angle into grating 19a of θᵢₙ=0° the demultiplexed output beams are collected in angles θₒᵤₜ=−17.94° and θₒᵤₜ=−30.89° for the first and second reference optical waveforms respectively.

Given the above grating specifications the laser source 10 as shown in FIG. 1A must have a maximum temporal pulse width (FWHM) of 1 ps (given by the minimum Δτₚ of the two segmented gratings).

Manufacturing segmented gratings: Using lithography (optical or electron beam) surface profiles can be written onto a substrate point by point. Thus segmented gratings with spatial phase shifts between the subgratings can be written directly onto a transmitting or reflecting surface. Control of subgrating amplitude is also possible using this technique.

It is also possible to use a variety of holographic techniques to successively or simultaneously record subgratings with controlled surface profile properties.

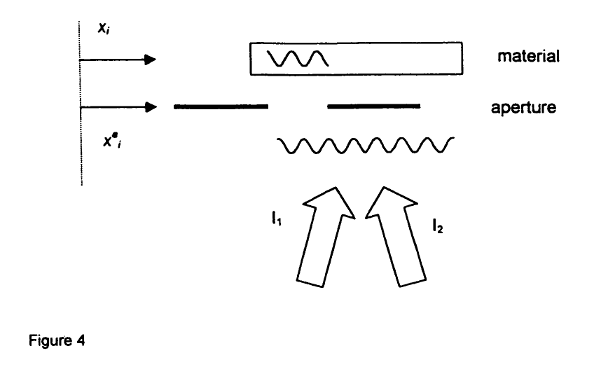

FIG. 4 illustrates how the segmented grating can be manufactured by spatial repositioning of the grating substrate to produce subgratings with controlled spatial phase. The angle between the two beams or the wavelength of the two beams used in standard holographic recording can be used to control the grating spacing Λᵢ. Spatial phase shifts may be introduced between exposures by translating the grating substrate. Thus, the N subgratings can be recorded, as shown in FIG. 4, by spatially translating an aperture mask of width d=D/N (where D is the total grating length) by its width N times and exposing the recording material at each mask position. Between exposures, the grating substrate is shifted along the groove-normal line. The substrate shifts a distance xᵢ relative to a fixed reference prior to exposure of subgrating i. Control of writing beam intensity between subgrating exposures allows for subgrating amplitude Aᵢ control.

A similar method of producing segmented gratings comprised of subgratings with spatial phase shifts uses single exposure holography with a phase-code mask having the appropriate subgrating phase shifts encoded in its optical thickness. The mask is placed in one of the two interfering beams in close proximity to the substrate. If these beams are incident from opposite sides of the substrate, this phase-mask can be contacted directly onto the grating substrate.

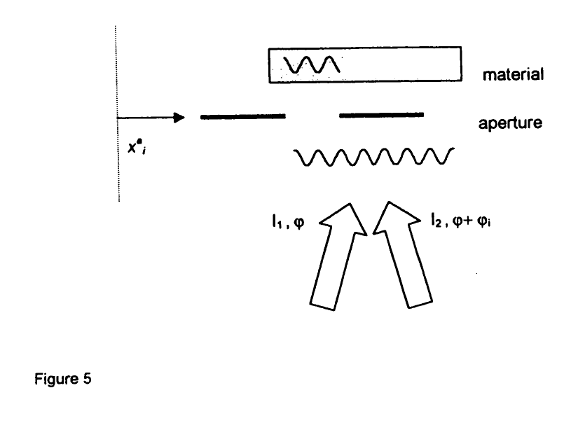

FIG. 5 shows a holographic method for fabricating gratings with N subgratings with controlled spatial phase shifts. This technique controls the phase-difference, φᵢ, between the two optical writing beams as shown in FIG. 5. Control of writing beam intensity allows for control of subgrating amplitude as well. The optical phase-difference determines the position of the interference pattern on the sample where the beams overlap, and their intensity controls the modulation amplitude of the interference pattern. The subgratings are recorded by illuminating the whole sample region with the interference pattern, but using an aperture of width d so that only the region behind the aperture is exposed and recorded. By spatially shifting the aperture across the sample in N steps it is possible to write a series of N subgratings, with each grating having a phase determined by the phase-difference φᵢ used during exposure of the i^{th} subgrating.

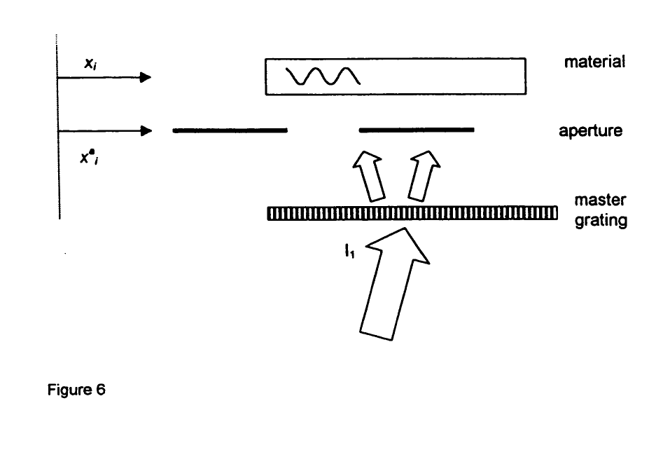

FIG. 6 illustrates an approach to producing subgratings termed the “master phase mask” approach. In this approach a single writing beam is used in conjunction with a master phase mask diffraction grating. A single beam incident on a master grating will be diffracted to yield one or more extra output beams. The incident and diffracted beams will interfere producing an interference pattern that can be used to record a near duplicate of the master grating as known in the art. This property of diffraction gratings makes it possible to use a master grating to generate the interference pattern needed for the grating. The phase in each subgrating is imparted by translating the master grating or the recording substrate between successive masked subgrating exposures.

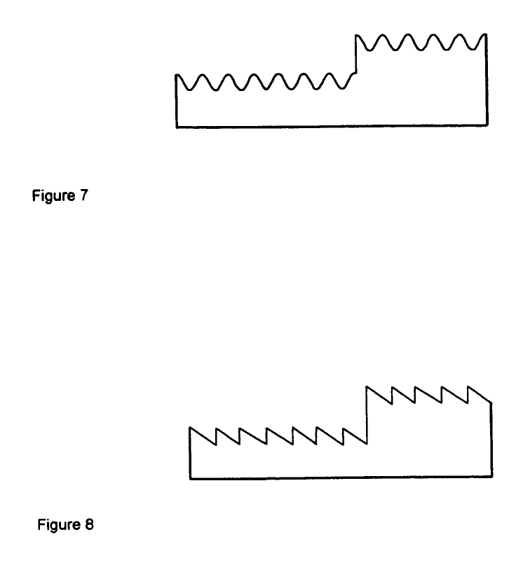

Control of substrate optical thickness and thus phase shift φᵢ: FIG. 7 shows a two segment grating wherein the subgratings are written onto a substrate of varying thickness. Variation in substrate thickness provides for control over the subgrating parameter φᵢ. More generally, φᵢ can be controlled by any of the means known in the art for varying the optical path length of the subgrating substrates. For example, index of refraction changes between subgrating substrates provides for control over φᵢ.

A variety of fabrication methods support control over φᵢ. Lithography provides for changes in surface level (and hence substrate thickness) as well as groove profile. Programmed lithographic variations in surface level thus provide control over φᵢ. Holographic, lithographic, or mechanical ruling methods can be implemented on a substrate that has been prepared to have specified optical thickness throughout the spatial region occupied by each subgrating. Control over optical thickness can be achieved by any of the means known in the art including but not limited to etching and thin-film coating.

The value of φᵢ for each subgrating can also be controlled through use of a separate phase mask placed over a constant thickness substrate.

Production of Segmented gratings through Fourier Synthesis: A grating may be made by a Fourier synthesis method by superposition of multiple periodic gratings each of which spans the entire width of the segmented grating. The constituent periodic gratings have relative phases, amplitudes, and spatial periods such that when summed they result in the segmented grating profile of interest. The constituent periodic gratings are the Fourier components of the desired grating profile. The more Fourier components used the more sharply defined the subgratings will be.

The gratings can be manufactured by holographic or lithographic methods. By exposing a photosensitive substrate with multiple holographic exposures each of which writes a particular constituent periodic grating, the desired grating profile can be recorded. Lithographic means also provide for multipass writing wherein each pass is employed to write one constituent periodic grating.

Gratings with specific groove profiles (Blazing): By using lithographic and holographic methods the gratings may have an arbitrary modulation profile which include saw-tooth blazed, square wave, sine wave, etc. in order to engineer the distribution of power into the diffraction orders. FIG. 8 is a schematic of a grating similar to that shown in FIG. 2B, but with a saw-tooth modulation profile.

It is noted that the descriptions of the segmented gratings presented in this document can be generalized to include gain gratings as well as absorption gratings, fiber gratings, and gratings in frequency selective materials.

Dynamic Gratings: In the embodiments described above, the gratings have been static. The following describes an embodiment wherein the gratings can be dynamically reprogrammed with respect to their spectral filtering functions.

In the previously described embodiments, the spectral transfer function of the gratings is determined by the parameters Aᵢ, φᵢ, xᵢ, and Λᵢ of its constituent subgratings. Generally speaking, any means known in the art that provides for dynamic control of one or more of these parameters will enable dynamic reprogramming of gratings. A variety of construction methods allow for dynamic reconfiguration of gratings. For example: Control of φᵢ and Aᵢ through control of substrate or overlay index of refraction. A grating created by the means described above may be overlain with a material whose index of refraction can be controlled by any of the standard means known in the art including, for example, applied electric field, pressure, current, or optical irradiation. If the means of controlling the index of the overlayer is applied to act differentially over spatial regions essentially coinciding with the subgratings comprising the grating either φᵢ or Aᵢ can be controlled. To control φᵢ alone, an overlayer may be applied to the side of the substrate opposite to the grooves. Variation in optical thickness in the overlayer induced by any means known in the art then allows one to vary φᵢ. If the overlayer is applied to the groove side of the grating (filling in the grooves) both φᵢ and Aᵢ can be controlled. Aᵢ may be controlled by changing the difference in refractive index between the grooves and the overlayer. φᵢ can be controlled by controlling the optical path length of the overlayer (as in the case when the overlayer is applied on the substrate side opposite the grooves). The ratio Δ Aᵢ/Δφᵢ may be varied by adjusting the thickness of the overlayer. Here Δ Aᵢ(Δφᵢ) is the change in Aᵢ(φᵢ) introduced by a given change in refractive index of the overlayer. Control of Aᵢ alone can be achieved by a variety of means including the addition of overlayers on both sides of the grating substrate and configuration of the overlayers so that the optical path difference introduced by index changes of the two layers cancels and thus so does the change in φᵢ. On the other hand, the change in amplitude of the phase subgratings is sensitive to the index change of only one of the overlayers and does not cancel. Pure Aᵢ control can also be obtained by stacking two differentially controlled overlayers on the groove side of the grating. Again, the optical path difference on passing through both layers is constrained to be constant.

Control of the complex φᵢ through control of substrate or overlay transmission: In the following paragraph we reinterpret hᵢ(x′) in Eq. (1) to define the generalized complex amplitude transmission function of a grating to be given by:
Hᵢ(x′)=exp(jhᵢ(x′)) (5)

In this representation we allow hᵢ(x′) to be complex in order to include gain or absorption gratings in the above presented treatment. When the amplitude factor Aᵢ is considered to be complex, the imaginary part subsequently describes the loss or gain grating amplitude. Furthermore, by generalizing φᵢ to be a complex number, we include the possibility of subgrating absorption or gain introduced by a variation in substrate transmission or a superimposed amplitude mask.

A grating, as described earlier, may be overlain with a material whose optical intensity transmission can be controlled by any of the standard means known in the art including, for example, with a liquid crystal amplitude modulator or an electro-absorptive material. If the means of controlling the transmission of the overlayer is applied to act differentially over spatial regions essentially coinciding with the subgratings comprising the segmented grating, the imaginary part of φᵢ can be controlled. Changing on, will effect a change in the transfer function T(ν) as described in Eqs. (1-4).

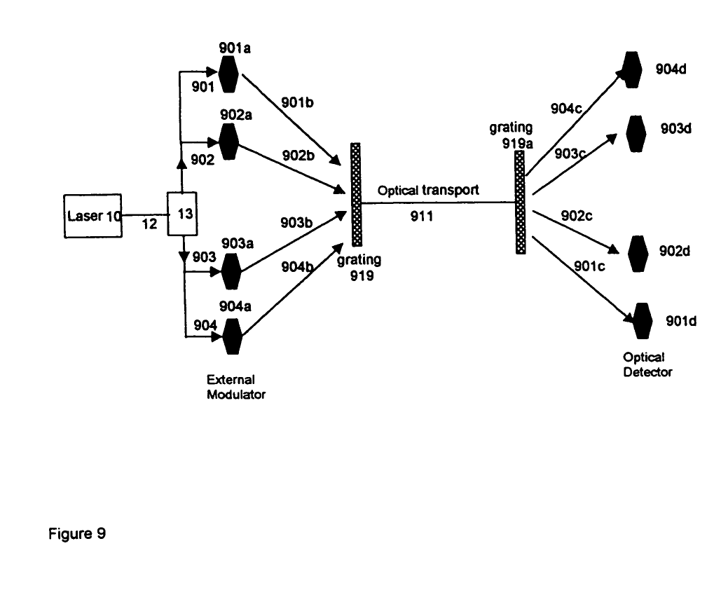

In the preferred embodiment shown in FIG. 1, two optical channels are multiplexed using OCDMA coding. As illustrated in the embodiment shown in FIG. 9, additional channels can be encoded, multiplexed, transmitted and then demultiplexed. In the embodiment shown in FIG. 9, four channels 901, 902, 903 and 904 are modulated by modulators 901a to 904a, multiplexed by grating 919, transmitted on fiber 911, demultiplexed by grating 919a, and then detected by detectors 901d to 904d. The gratings 919 and 919a consist of four superimposed segmented gratings of the type previously described.

While the invention has been described with respect to preferred embodiments thereof, it will be understood by those skilled in the art that various changes in format and detail may be made without departing from the spirit and scope of the invention. Applicant's invention is limited only by the appended claims.

1-16. (canceled)

17. A process comprising:
directing first and second optical signals onto a segmented diffraction grating formed on a substrate, the segmented diffraction grating comprising a first sub-grating and a second sub-grating;
diffracting the first optical signal with the first sub-grating, the first sub-grating having a first grating period; and
diffracting the second optical signal with the second sub-grating, the second sub-grating formed on the substrate parallel to the first sub-grating and separated from the first sub-grating by a selected non-zero distance, wherein the second sub-grating has a second grating period different than the first grating period.

18. The process of claim 17 wherein the selected distance is positive.

19. The process of claim 17 wherein the selected distance is negative, such that the first sub-grating and the second sub-grating overlap.

20. The process of claim 17, further comprising routing the first and second optical signals into an optical carrier after diffraction by the first and second sub-gratings.

21. The process of claim 20 wherein the optical carrier comprises an optical fiber.
